(19) United States
(12) Patent Application Publication
(10) Pub. No.: US 2006/0120617 A1
(43) Pub. Date: Jun. 8, 2006

(54) Image processing apparatus and method

(75) Inventor: Sang Wook Park, Gimpo-si (KR)

Correspondence Address: JONATHAN Y. KANG, ESQ.;LEE, HONG, DEGERMAN, KANG & SCHMADEKA, 14th Floor, 801 S. Flgueroa Street, Los Angeles, CA, 90017, US

(73) Assignee: LG Electronics Inc.

(21) Appl. No.: 11/292,890

(22) Filed: Dec. 2, 2005

(30) Foreign Application Priority Data
Dec. 3, 2004 (KR) 10-2004-0100923

(51) Int. Cl. G06K 9/40; G06K 9/48

(52) U.S. Cl. 382/255; 382/199

(57) ABSTRACT

An image processing apparatus and method are provided. An image processing apparatus includes a contour extraction unit for extracting number of pixels according to a high frequency component from an inputted image, a focus level calculator for calculating a focus level of the inputted image according to the number of the pixels, and a contour processing unit for performing a filtering operation according to the focus level.

This application claims the benefit of the Korean Patent Application No. 10-2004-0100923, filed on Dec. 3, 2004, which is hereby incorporated by reference as if fully set forth herein.

### BACKGROUND OF THE INVENTION

1. Field of the Invention

The present invention relates to an image processing apparatus, and more particularly, to an image processing apparatus and method capable of improving sharpness of an image.

2. Description of the Related Art

Currently, a mobile communication terminal such as a mobile phone, a personal digital assistant (PDA), a smart phone or the like, has a high quality camera built-in so that it has functions of taking an image and reproducing it.

Most of users recognize that this camera function provided by the mobile communication terminal is a basic function. Thus, the camera function of the mobile communication terminal is variously used for taking an image of a name card, a user's face oneself or a landscape, and then the taken image is transferred to an opponent user's mobile communication terminal. In addition, the camera function is also used for taking an image of a traffic accident on real-time, which may be made use of an evidence material. In this manner, the camera function of the mobile communication terminal tends to be increasingly applied to various ways nowadays.

The mobile communication terminal incorporating the camera does not have a device for adjusting a focus separately, but it provides an auto focusing function through control of a sensor. However, there is a great limitation in a focal length for applying the auto focusing function to the camera of the mobile communication terminal. Thus, there may often occur defocus phenomenon when taking an image of an object which stands too far or too close from the camera.

Meanwhile, there has been proposed a method for adjusting the focus through mechanical control in an image-capturing device such as a digital camera and a digital camcorder.

However, in case of the image-capturing device which does not have a mechanical focus adjusting device, there are also considerably great limitations in the focus adjustment function as similar as the mobile communication terminal stated above.

In this case, an attempt has been made to compensate for a contour of an image to be sharpened by applying a digital image processing method, which is yet imperfect.

The digital image processing method proposed up to date employs a contour emphasizing method through a sharpening filter in order to compensate for the phenomenon that the taken image becomes blurred.

That is, there has been suggested a method for producing a contour emphasizing data by adding/subtracting a predetermined luminance value based on a slope of an edge after extracting the edge from a digital-converted image, wherein a predetermined portion where luminance variation between each pixel is too large is extracted as the edge by comparing a luminance value of each pixel.

In addition, there has proposed a method for sharpening a contour as followings. According to this method, to begin with, a pixel difference between a previous image and a next image with respect to a pixel of a current image is calculated and the pixel difference is compared with a critical value. Thereafter, if the pixel difference is greater than the critical value, it is determined as a boundary so as to perform a high-pass filtering, i.e., a current pixel data is replaced by a high-pass filtered data. On the contrary, if the pixel difference is less than the critical value, the current pixel data is used intactly. Through this method, therefore, the contour of the image becomes sharpened.

However, these related art technologies or methods are uniformly applied to various images regardless of whether or not the taken image is accurately focused on. Thus, it is difficult to apply these related art technologies to certain cases that a focal length between the object and the lens is too short or too long so that the focal length is out of a predetermined range, i.e., the taken image is too defocused.

The related art technologies only have a compensation effect on a blurred image which is not too defocused in generally taking the image. Therefore, if the focal length is out of the predetermined range itself, it is hard to render the blurred image be sharpened.

Accordingly, there is a great need for developing a new image processing device having an enhanced compensation effect even though the focal length is severely out of the predetermined range on a digital image capturing device.

Furthermore, a need is also raised to develop the image processing device with an optimum compensation effect by discriminating a degree of defocusing, and by selecting/performing an image process differently and correspondingly in accordance with the degree of defocusing.

Moreover, it is necessarily required to improve the image processing apparatus for selecting only a contour portion required for enhancing the image by minimizing the noise affection, and further performing the image process effectively on the selected contour portion.

### SUMMARY OF THE INVENTION

Accordingly, the present invention is directed to an image processing apparatus and method that substantially obviates one or more problems due to limitations and disadvantages of the related art.

An object of the present invention is to provide an image processing apparatus for performing an image process differently according to a defocused level by determining the defocused level in accordance with the number of pixels which are defocused after discriminating defocused portions from noise portions and extracting the defocused portions.

Another object of the present invention is to provide an image processing apparatus for performing an optimized filtering on a taken picture by differentiating a size, a filter coefficient, and a number of filtering on the image of a high-pass filter according to a defocused level.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an image processing apparatus including: a contour extraction unit for extracting number of pixels according to a high frequency component from an inputted image; a focus level calculator for calculating a focus level of the inputted image according to the number of the pixels; and a contour processing unit for performing a filtering operation according to the focus level.

In another aspect of the present invention, there is provided an image processing apparatus including: a contour extraction unit for extracting number of pixels having a high frequency component except a noise component from an inputted image; a focus level calculator for discriminating the inputted image into a plurality of levels according to the number of the pixels; and a contour processing unit for varying a sharpness of an image using a high pass filtering mask which is selected according to the level.

In a further another aspect of the present invention, there is provided a method for processing an image, the method including: calculating a first value by applying a high frequency mask to a luminance value of a pixel constituting an inputted image; calculating number of a pixel having a high frequency component with a predetermined range by comparing the first value with a critical value; and filtering the inputted image in accordance with the number of the pixel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an image processing apparatus according to an embodiment of the present invention;

FIG. 2 is a flow chart illustrating a procedure for performing a high-pass filtering masking according to a focus level at the image processing apparatus 100 which compensates a defocus phenomenon according to the present invention;

FIG. 3A is a drawing of a high frequency mask according to an embodiment of the present invention;

FIG. 3B is a drawing illustrating a local image of a taken image where the high frequency mask is applied according to an embodiment of the present invention;

FIG. 3C is a drawing illustrating a procedure that the high frequency mask is applied to each local image in sequence according to an embodiment of the present invention;

FIG. 3D is a functional equation of an image process representing a mask response with respect to a pixel of a spatial region according to an embodiment of the present invention;

FIG. 4 is a flow chart of a procedure that the image processing apparatus calculates a focus level according to an embodiment of the present invention;

FIG. 5A is a drawing of a first high-pass filtering mask according to an embodiment of the present invention; and

FIG. 5B is a drawing of a second high-pass filtering mask according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

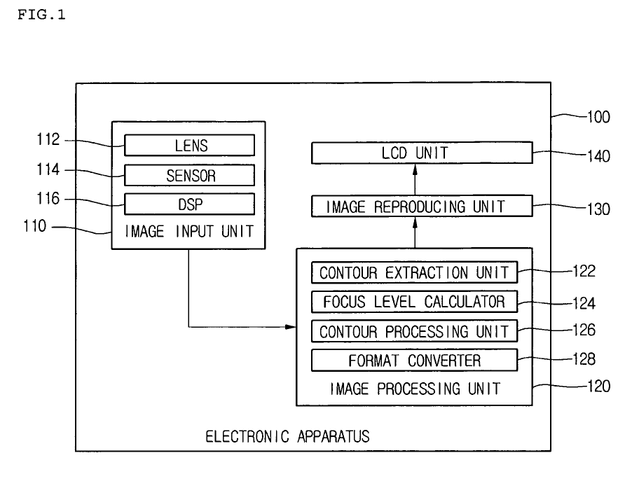

FIG. 1 is a schematic block diagram of an internal constitution of an electronic apparatus 100 illustrating an image processing apparatus according to an embodiment of the present invention. Herein, the electronic apparatus 100 may be various devices receiving an image signal and outputting an image, such as a mobile communication terminal, a camcorder, a digital camera, a personal digital assistant (PDA), a smart phone, a notebook computer and so forth.

Referring to FIG. 1, the electronic apparatus 100 according to an embodiment of the present invention, includes an image input unit 110, an image processing unit 120, an image reproducing unit 130, and a liquid crystal display (LCD) unit 140.

The image processing unit 120 is configured with a contour extraction unit 122, a focus level calculator 124, a contour processing unit 126, and a format converter 128.

The image input unit 110 is configured with a lens 112, a sensor 114, and a digital signal processor (DSP) 116. When a light signal is sensed at the lens 112, the DSP 116 convert the sensed light signal into a digital image data.

The image reproducing unit 130 reproduces the image which has been captured by the image input unit 110 and digitally processed by the image processing unit 120. The image may be reproduced at predetermined frames per second.

When image reproducing unit 130 reproduces the image, the image reproducing unit 130 controls the LCD panel also. Accordingly, the LCD unit 140 provided with an LCD panel, displays a reproduced image.

The image processing unit 120 compensates the taken image by sharpening the contour of the image in case that the taken image is defocused and it transfers the compensated image to the image reproducing unit 130.

To begin with, the contour extraction unit 122 included in the image processing unit 120 extracts a pixel having a high frequency component among the inputted images. In case that the taken image is defocused, it seem to be represented a plurality of boundaries of an image and a plurality of portions where a brightness is abruptly changed.

That is, the portion where the brightness is abruptly changed is a portion that has the high frequency component. Thus, it is possible to obtain a sharpened contour of the image by extracting the pixel corresponding to this portion and performing the image process on this pixel.

Herebelow, each function of the contour extraction unit 122, the focus level calculator 124, the contour processing unit 126 and the format converter 128 included in the image processing unit 120, will be illustrated more detail with reference to a flow chart in the drawings.

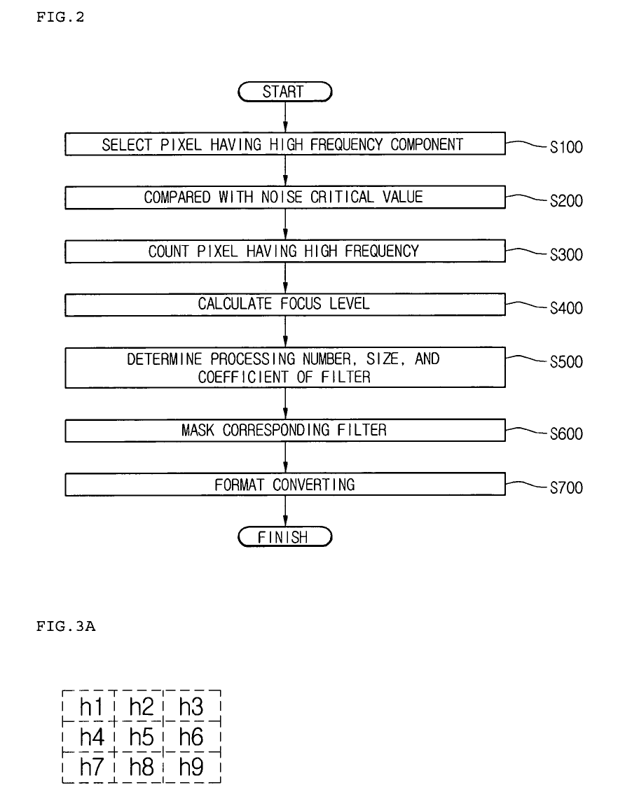

FIG. 2 is a flow chart illustrating a procedure for performing a high-pass filtering masking in accordance with a focus level at the image processing unit 120 according to the present invention.

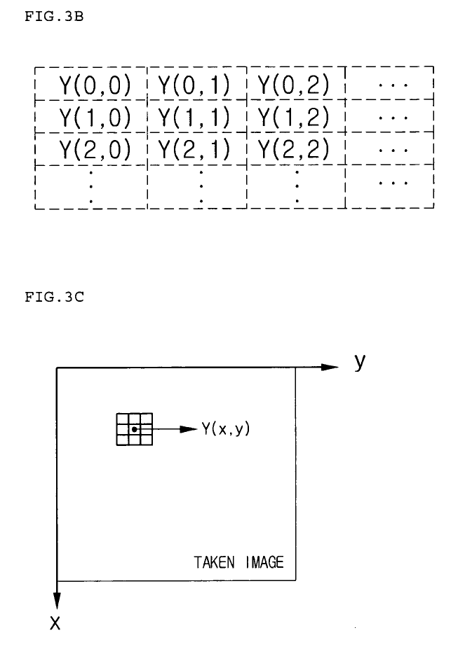

FIG. 3A is a drawing of a high frequency mask, and FIG. 3B is a drawing illustrating a local image of a taken image where the high frequency mask is applied, according to an embodiment of the present invention. In addition, FIG. 3C is a drawing illustrating a procedure that the high frequency mask is applied to each local image in sequence, and FIG. 3D is a functional equation of an image process representing a mask response with respect to a pixel of a spatial region according to an embodiment of the present invention.

The contour extraction unit 122 performs a high frequency masking on a corresponding image in order to extract the pixel having the high frequency component, which will be set forth herebelow.

First, as illustrated in FIG. 3A, the contour extraction unit 122 has a high frequency mask of 3×3 matrix size and the high frequency mask has a predetermined mask coefficient (h1˜h9).

As illustrated in FIG. 3C, the contour extraction unit 122 selects the pixel having the high frequency component by applying the high frequency mask to the local image of the taken image in sequence (S100). Although there is illustrated the local image in FIG. 3B, FIG. 3B only shows the first local image on an x axis and a y axis among whole the taken images.

At this time, the contour extraction unit 122 selects the pixel having high luminance difference from a peripheral pixel by applying the high frequency mask to each luminance value of the pixels constituting the taken image. In an equation represented as Y(x,y) in FIG. 3C, a capital letter Y means the luminance value, and lowercase letters x and y denote a location of each pixel of whole the images in the coordinates.

Considering the functional equation of the image process in FIG. 3D, the luminance value of each pixel and the coefficient of each high frequency mask are integrated through a convolution operation and all the integral results are added. Through this operation, it is possible to know a luminance difference DL between a central pixel corresponding to a center of the high frequency mask and adjacent pixels. The central pixel which is a target pixel to be discriminated, is correspondent to the equation Y(x,y) of FIG. 3C.

Like this, the contour extraction unit 122 may select the pixel having the high frequency component by discriminating the pixel that an absolute value of the luminance difference DL is greater than a first critical value.

That is, from the functional equation of FIG. 3D, if the absolute value of the luminance difference between a specific pixel and its neighboring pixel is compared with the first critical value and the absolute value is greater than the first critical value, it is determined as the pixel having the high frequency component.

Thereafter, the contour extraction unit 122 sets a second critical value corresponding to a boundary which the luminance difference may be determined as a noise. Afterwards, the absolute value of the luminance difference DL calculated from the functional equation of the image process is compared with the second critical value (S200). Subsequently, the pixel having the luminance difference equal to or greater than the second critical value is determined as the pixel having the high frequency component and a counting is performed (S300).

That is, from FIG. 3D, after comparing the absolute value of the luminance difference DL between the specific pixel and its neighboring pixel, it is determined as the noise in case that the luminance difference is greater than the second critical value.

Through theses operations, it is possible for the image processing apparatus 100 according to the embodiment of the present invention to select the pixel having the high frequency component by minimizing the noise affection and effectively process digital filtering.

Afterwards, the focus level calculator 124 calculates the focus level according to the number of the pixel counted by the contour extraction unit 122.

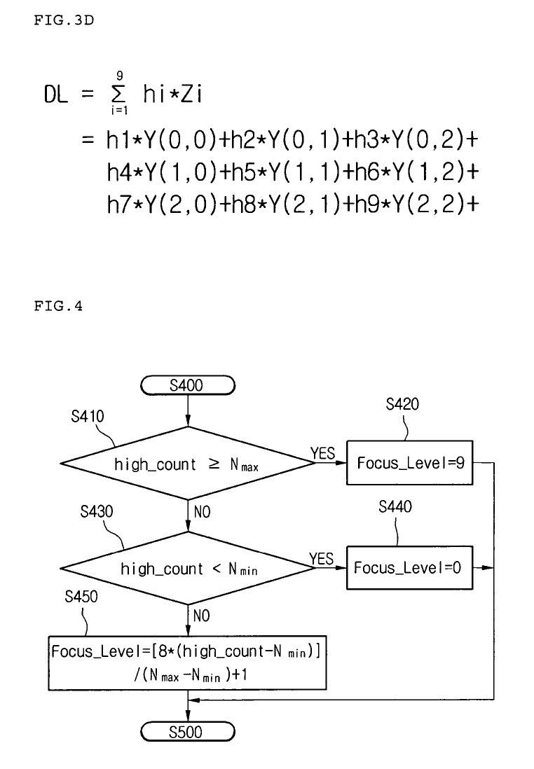

The number of the pixel having the high frequency component is represented as high_count in FIG. 4.

The image processing unit 120 according to the embodiment of the present invention calculates the focus level for every taken image and performs the filtering differently corresponding to the calculated results. Therefore, it is possible to perform an optimized filtering according to the degree of defocus.

FIG. 4 is a flow chart of a procedure that the image processing apparatus calculates a focus level according to an embodiment of the present invention.

Referring to FIG. 4, the focus level calculator 124 calculates the focus level as an nth grade, e.g., a ninth grade in FIG. 4 (S420), if the number of the pixel high_count having the high frequency component is Nmax or greater (S410). On the contrary, in case that the number of the pixel high count having the high frequency component is Nmin or less (S430), the focus level calculator 124 calculates the focus level as a zeroth grade (S440).

Herein, Nmax and Nmin are numerical values which may be statistically determined. That is, these values are determined under the conclusion that it is most effective in characteristics of visual conception to differentiate the filtering when the number of the pixel high_count having the high frequency component is between Nmax and Nmin.

When the number of the pixel high_count having the high frequency component is equal to or greater than Nmin and less than Nmax (e.g., when results of operations S410 and 430 are “NO”, respectively), the focus level calculator 124 calculates the focus level as a predetermined grade expressed as an equation,

$$\frac{( n - 1 ) \times ( high\_count - N min )}{N max - N min} + 1 ( S500 ) .$$

In this case, if the focus level is classified into the zeroth to the ninth one, the focus level calculator 124 applies the taken image to an equation,

$$\frac{8 \times ( high\_count - N min )}{N max - N min} + 1 ,$$

and sorts the focus level.

After the focus level calculator 124 calculates the focus level of the taken image, the contour processing unit 126 performs the filtering operation differently on the image according to the focus level.

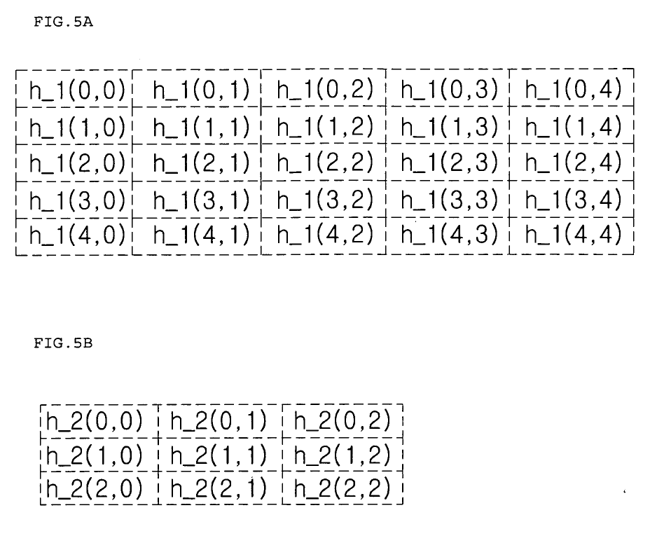

FIG. 5A is a drawing of a first high-pass filtering mask and FIG. 5B is a drawing of a second high-pass filtering mask, according to an embodiment of the present invention.

The contour processing unit 126 has a plurality of high pass filtering mask having respective sizes and filter coefficients which are different from one another. The taken image is filtered by selecting the high pass filtering mask corresponding to the focus level according to the focus level calculated at the focus level calculator 124.

The image processing unit 120 according to the embodiment of the present invention, has two filtering masks, of which one is the first high-pass filtering mask with 5×5 matrix illustrated in FIG. 5A. Herein, each filter coefficient of the element h_1 (0,2), h_1 (2,0), h_1 (2,4) and h_1 (4,2) is −0.25. Besides these, the filter coefficient is all 0.

In addition, the second high-pass filtering mask has 3×3 matrix as illustrated in FIG. 5B. Herein, each filter coefficient of the element h_2 (0,1), h_2 (1,0) and h_2 (1,2) is −0.25. Besides these, the filter coefficient is all 0.

Through such an arrangement of the coefficient in the mask, scattered high frequency components may be concentrated on one pixel, which results in improving the sharpness of the total image.

[Mathematic equation 1]

Y=H2*H1*X; First Functional Equation

Y=H2*X; Second Functional Equation

Herein, Y(i,j) denotes the pixel of the image of which the contour is sharpened by the filtering, and X(i,j) denotes the pixel of the taken image which is defocused. Furthermore, H1 and H2 represent the first and second high-pass filtering masks, respectively. A symbol “*” means the convolution operation.

As expressed in the mathematic equations, the contour processing unit 126 may perform the high-pass filtering masking operation differentiated number of times according to the calculated focus level.

In the embodiment of the present invention, if the focus level is 5 or more, the image process is performed through the first functional equation. Herein, the first functional equation denotes that the taken image is integrated with the first and second high-pass filtering masks through the convolution operation.

Meanwhile, provided that the focus level is 4 or less, the image process is performed through the second functional equation. Herein, the second functional equation represents that the taken image is integrated with the second high-pass filtering mask through the convolution operation.

That is, if the focus level is 5 or more, the contour processing unit 126 performs the image process two times. If the focus level is 4 or less, the contour processing unit performs the image process once.

At this time, in structuring the contour processing unit 126 with the high-pass filtering mask, in case that the image process is performed through a plurality number of times, it is preferable to configure the contour processing unit 126 by combining a size and a coefficient of the high-pass filtering mask such that a filtering effect for each time is decreased in proportional to the plurality number of time.

As stated above, if the focus level calculator 124 calculates the focus level of the taken image, i.e., the defocused level of the image, the contour processing unit 126 determines a processing number of the high-pass filter. Accordingly, the contour processing unit 126 varies the size and the coefficient of each high-pass filtering mask (S500).

Afterwards, the contour processing unit 126 performs the high-pass filtering mask through the convolution operation (S600), so as to sharpen the contour of the taken image of which the focus is defocused, at last.

The format converter 128 converts the image data in which the contour is sharpened into a regular format. For example, a series of image process (data compression) such as joint photographic experts group (JPEG) may be used.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An image processing apparatus comprising:
a contour extraction unit for extracting number of pixels according to a high frequency component from an inputted image;
a focus level calculator for calculating a focus level of the inputted image according to the number of the pixels; and
a contour processing unit for performing a filtering operation according to the focus level.

2. The image processing apparatus according to claim 1, wherein the contour extraction unit selects a pixel having the high frequency component by applying a high frequency mask to the inputted image in sequence.

3. The image processing apparatus according to claim 1, wherein the contour extraction unit selects the pixel having the high frequency component by comparing an absolute value of a luminance difference between adjacent pixels with a critical value.

4. The image processing apparatus according to claim 3, wherein the critical value has a first critical and a second critical value, the contour extraction unit determining the pixel having the high frequency component in case that the absolute of the luminance difference is equal to or greater than the first critical value and is equal to or less than the second critical value.

5. The image processing apparatus according to claim 1, wherein the contour processing unit performs the filtering operation differently according to the focus level.

6. The image processing apparatus according to claim 1, wherein the contour processing unit performs the filtering operation on the image by selecting one among a plurality of high pass filtering masks of which sizes and filter coefficients are different from one another according to the focus level.

7. The image processing apparatus according to claim 1, wherein the contour processing unit performs the filtering operation by varying the number of times according to the focus level.

8. An image processing apparatus comprising:
a contour extraction unit for extracting number of pixels having a high frequency component except a noise component from an inputted image;
a focus level calculator for discriminating the inputted image into a plurality of levels according to the number of the pixels; and
a contour processing unit for varying a sharpness of an image using a high pass filtering mask which is selected according to the level.

9. The image processing apparatus according to claim 8, wherein the contour extraction unit determines the imputed image as a noise in case that an absolute value of a luminance difference between each pixel and adjacent pixel of the inputted image is more than a preset critical value.

10. The image processing apparatus according to claim 8, wherein the focus level calculator discriminates the inputted image into a level n if the number of the pixel (high_count) is Nmax or greater, a level 0 if the number of the pixel is less than Nmin, and a level
$$\frac{( n - 1 ) \times ( high\_count - N min )}{N max - N min} + 1$$
if the number of the pixel is equal to or greater than Nmin and less than Nmax.

11. The image processing apparatus according to claim 8, wherein the contour processing unit performs a convolution operation on a plurality of high-pass filtering masks with a luminance value of the pixel in accordance with the level of the image.

12. The image processing apparatus according to claim 8, wherein the contour processing unit determines a processing number of the high-pass filtering mask, and varies a size and a coefficient of the high-pass filtering mask according to the processing number.

13. A method for processing an image, the method comprising:
calculating a first value by applying a high frequency mask to a luminance value of a pixel constituting an inputted image;
calculating number of a pixel having a high frequency component with a predetermined range by comparing the first value with a critical value; and
filtering the inputted image in accordance with the number of the pixel.

14. The method of claim 13, wherein the first value is an absolute value of a luminance difference between each pixel constituting the image and an adjacent pixel.

15. The method of claim 13, wherein the critical value has a first critical value and a second critical value, the number of the pixel having the high frequency component with the predetermined range being a number of the pixel that the first value is equal to or higher than the first critical value and is equal to or lower than the second critical value.

16. The method of claim 13, wherein the filtering is performed using the high-pass filtering mask.

17. The method of claim 16, wherein the coefficient of the high-pass filtering mask is varied with the number of the pixel.

18. The method of claim 16, wherein the size of the high-pass filtering mask is varied with the number of the pixel.

19. The method of claim 13, wherein a number of filtering on the inputted image are varied with the number of the pixel.
